(19) United States
(12) Patent Application Publication
(10) Pub. No.: US 2023/0185753 A1
(43) Pub. Date: Jun. 15, 2023

(54) INLINE ACTUATOR

(71) Applicant: HEWLETT-PACKARD DEVELOPMENT COMPANY, L.P., Spring, TX (US)

(72) Inventors: Michael Delpier, Spring, TX (US); Chad Paris, Spring, TX (US)

(73) Assignee: HEWLETT-PACKARD DEVELOPMENT COMPANY, L.P., Spring, TX (US)

(21) Appl. No.: 17/924,472

(22) PCT Filed: May 29, 2020
(86) PCT No.: PCT/US2020/035174

§ 371 Date: Nov. 10, 2022

(51) Int. Cl. G06F 13/40; G06F 13/42

(52) U.S. Cl. CPC G06F 13/4068; G06F 13/4282; G06F 2213/0042

(57) ABSTRACT

Examples are described herein for inline actuators. In various examples, an apparatus to operably couple a computing device with a docking station may include: a first connector to be removably attached to the computing device; a second connector to facilitate removable coupling of the apparatus with the docking station; and an inline actuator arranged between the first connector and the second connector. The inline actuator may be actuable to cause a signal to be transmitted to the docking station or the computing device. The signal may directly or indirectly cause the computing device to transition from a first power state to a second power state.

### BACKGROUND

Mobile computing devices such as laptop computers often have limited input-output (“IO”) resources compared to “less mobile” computing devices such as desktop workstations. For instance, because a laptop computer's screen, keyboard, and mousepad are built into the device, they are usually smaller and/or less convenient to operate than their counterparts connected to a desktop workstation. Additionally, a laptop usually has one screen, whereas it is not uncommon to attach multiple monitors to a desktop workstation.

Docking stations (also referred to as “port replicators” or “docks”) are electronic devices with multiple ports that allow a mobile computing device such as a laptop computer to be operably coupled with peripheral components. This provides the user with the convenience of a mobile computing device and the increased capabilities of those peripheral components. As an example, a docking station allows a worker to carry the same laptop computer between multiple locations (e.g., work, home, business trips). This involves less administrative cost and labor than, for instance, providing the worker with separate computing devices at multiple locations.

### BRIEF DESCRIPTION OF THE DRAWINGS

Features of the present disclosure are illustrated by way of example and not limited in the following figure(s), in which like numerals indicate like elements.

FIG. 1 schematically depicts an apparatus configured with selected aspects of the present disclosure, in accordance with an example of the present disclosure.

FIG. 2 schematically depicts an apparatus configured with selected aspects of the present disclosure, in accordance with another example of the present disclosure.

FIG. 3 schematically depicts an apparatus configured with selected aspects of the present disclosure, in accordance with an example of the present disclosure.

FIG. 4 depicts an example method for practicing selected aspects of the present disclosure.

FIG. 5 depicts an example method for practicing selected aspects of the present disclosure.

### DETAILED DESCRIPTION

For simplicity and illustrative purposes, the present disclosure is described by referring mainly to various examples thereof. In the following description, numerous specific details are set forth in order to provide a thorough understanding of the present disclosure. However, examples consistent with the present disclosure may be practiced without limitation to these specific details. In other instances, some methods and structures have not been described in detail so as not to unnecessarily obscure the present disclosure.

The elements depicted in the accompanying figures may include additional components and that some of the components described in those figures may be removed and/or modified without departing from scopes of the elements disclosed herein. The elements depicted in the figures are not drawn to scale and the elements may have different sizes and/or configurations other than as shown in the figures.

In order to decrease power consumption, computing devices such as laptop computers are increasingly being designed to transition to lower power states such as sleep state when not in use (e.g., overnight). As an example, the Advanced Configuration and Power Interface (“ACPI”) specification provides for the efficient handling of power consumption in desktop and mobile computers. As examples, various processors may be transitioned between various “P-states” (e.g., P0, P1, etc.), “C-states” (e.g., C0, C1, etc.), and/or “S-states” (e.g., S0, S1, S2, S3, S4 etc.) in which they operate at different voltage and/or frequency levels.

When connected to a docking station during prolonged idle periods, a mobile computing device's transition to a lower power state may cause difficulties for the user upon their return. For example, the user may have to manually transition their laptop computer from a sleep state back to a working state in which the laptop may be operated to perform various computing tasks, e.g., by lifting the display of their laptop or pressing a hardware button. In the latter case, the hardware button may be on the docking station, which may be hard to reach, e.g., because the docking station has been positioned behind a monitor.

Examples are described herein for inline actuators that can be removably coupled between computing devices and docking stations. As used herein, “removably coupled” may refer to being directly or indirectly attached or connected to a computing device or docking station. These inline actuators may be actuable to cause the computing devices and/or docking stations to transition various hardware component(s) between various states, including power states and/or operational states. These inline actuators may be more conveniently located than, for instance, a docking station, which a user may wish to conceal or otherwise keep out of the way. In many examples these inline actuators may provide a more convenient way to, for instance, wake a laptop computer from a sleep state to a working state than opening the laptop slightly or reaching behind a display to find a similarly-functional button on the docking station.

In some examples, a cable such as a Universal Serial Bus (“USB”) C cable that is often used to connect laptop computers with docking stations (and hence, the peripherals connected to the docking station) may be equipped with an inline actuator at one end or the other, or in the middle of the cable. This inline actuator may be operated to cause a signal to be transmitted from circuitry of the inline actuator to one or both of the laptop computer and the docking station. Notably, in various examples, an electrical connection is maintained through the cable before, during, and after the transmission. This is in contrast to, for instance, a power cable that includes an internal switch that is operated to physically create or break an electrical connection between a device and a power source.

In various examples, the signal may be a control signal insofar as it controls some aspect of an electronic device. In some examples the signal may be modulated with information such that the signal operates as a command that causes an electronic device to take some specific action. In some examples, the signal may be unmodulated, but may control a connected electronic device by virtue of the signal's presence (or absence). In some such examples, a signal may be varied depending on a conductive path it takes. For example, applying current to one USB pin may cause an electronic device to take a first action, applying current to another USB pin may cause the electronic device to take a second action, and so forth.

The signal may cause the laptop computer or the docking station to transition various hardware component(s) between various states, such as power states (e.g., sleep, hibernate, working, soft off, etc.) and/or operational states (e.g., microphone off, activate camera shutter, etc.). For example, the signal may include a command that conforms with a USB standard to cause the docking station to transition its port(s) from an inactive state to an active state. These port transition(s) may in turn transition connected peripheral device(s), such as monitors, wireless mice, cameras, etc., from an inactive state to an active state. As another example, the signal may cause the laptop computer to transition itself from a first system-wide power state (e.g., sleep) to a second system-wide power state (e.g., awake or working).

In other examples, a portable device sometimes referred to as a “dongle” may be similarly equipped with an inline actuator. The dongle may, for instance, be removably attached at a first end to the docking station or computing device. A second end of the dongle may be attached to a cable such as a USB-C cable that in turn is attached to the other of the docking station or computing device. In some such examples, the second end of the dongle may be a female port to receive a male contact of a standard cable, and the first end of the dongle may be a male contact that will fit into a port of a computing device such as a laptop computer.

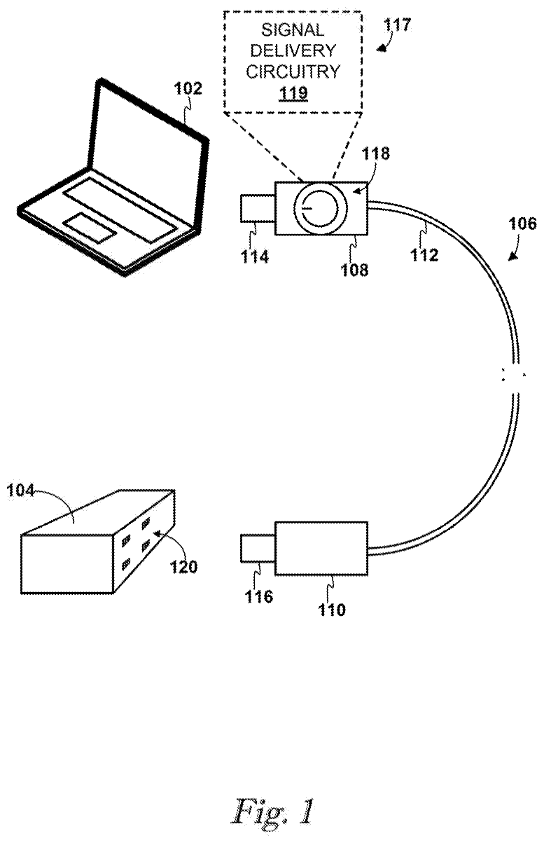

FIG. 1 schematically depicts an apparatus 106 configured with selected aspects of the present disclosure, in accordance with an example of the present disclosure. Apparatus 106 can be used to operably couple a computing device 102 with a docking station 104. In FIG. 1, computing device 102 takes the form of laptop computer, but other types of computing devices are contemplated, including but not limited to smart phones, tablet computers, set top boxes, wearable devices such as smart watches or smart glasses, and so forth. Computing devices that are operably coupled to docking stations are often mobile computing devices such as those just mentioned, but this is not the case in every example.

Docking station 104, which may alternatively be referred to as a “dock” or “port replicator,” is a device that can be used to operably couple computing device 102 with any number of peripheral devices. Peripheral devices may take various forms, including not limited to monitors, keyboards, mice, printers, projectors, cameras such as “webcams” that also include other input devices such as microphones, speakers, and any other input and/or output device.

Docking station 104 may include any number of ports 120 to which peripheral devices can be attached. In some examples, the port(s) 120 may be various types of USB ports, including but not limited to those referred to as USB-C, USC-A, microUSB, Micro-B, Mini-A, Mini-B, etc. Ports supporting other peripheral communication technologies are also contemplated, including but not limited to serial, DisplayPort (“DP”) technology, technology that combines peripheral component interconnect (“PCI”) express (“PCIe”) with DP technology, various types of digital visual interface (“DVI”), various types of high-definition multimedia interface (“HDMI”), video graphics array (“VGA”), etc.

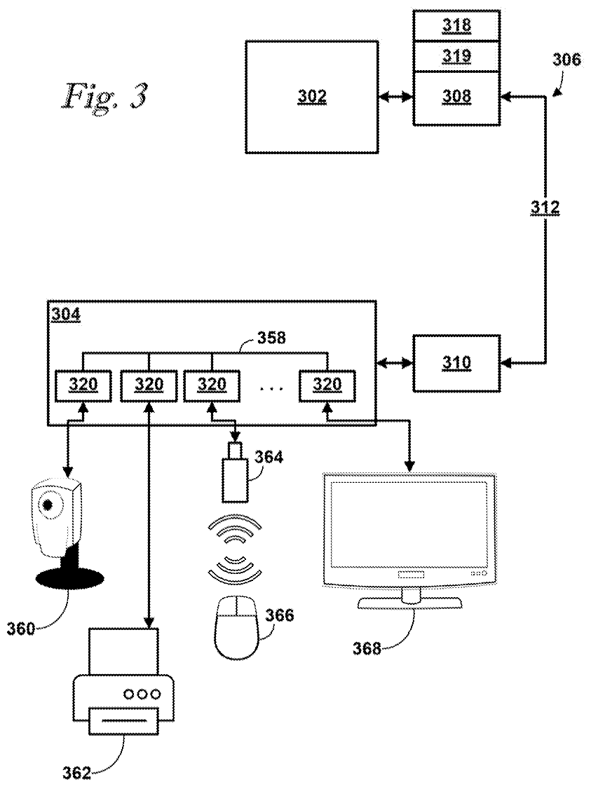

While not depicted in FIG. 1 in various examples, docking station 104 may be connected to a power supply such as AC mains. Accordingly, docking station 104 may act as a power supply to other components that are connected to it, including but not limited to computing device 102 and/or any peripheral devices that are also connected to docking station 104. Non-limiting examples of connected peripheral devices are depicted in FIG. 3, Some of these components may also include their own internal power supplies, such as batteries, which may or may not be recharged by docking station 104.

Apparatus 106 includes a first connector 108 to be removably attached to computing device 102. Apparatus 106 also includes a second connector 110 to facilitate removable coupling of apparatus 106 with docking station 104. In FIG. 1, for example, second connector 110 is to be removably attached to docking station 104, Other variations are contemplated. In FIG. 1, ports 120 are female ports, first connector 108 includes a male contact 114, and second connector 110 also includes a male contact 116. In some examples, the ports 120 are male ports and connectors 108 and 110 have female contacts.

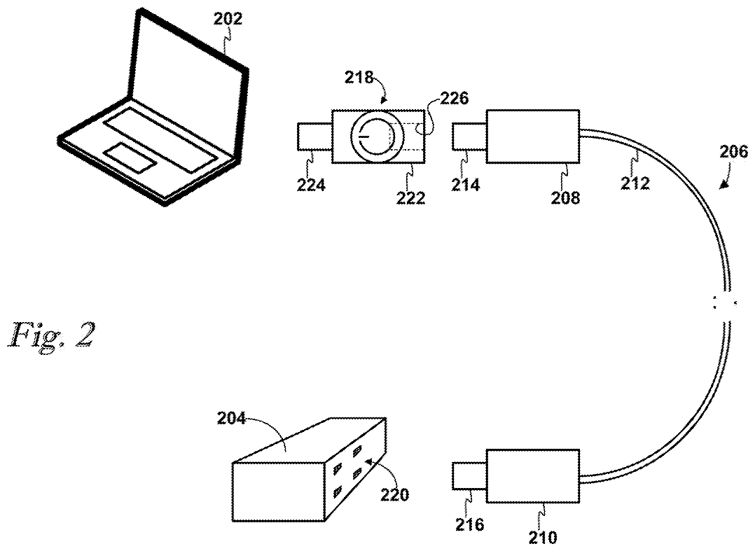

Apparatus 106 also includes, between first connector 108 and second connector 110, an elongate flexible portion 112 or “cable.” In FIG. 1, apparatus 106 takes the form of a cable. However, this is not meant to be limiting, and as will be seen in FIG. 2, for instance, inline actuators described herein are not limited to being deployed on cables.

Referring back to FIG. 1, apparatus 106 also includes an inline actuator 118 between first connector 108 and second connector 110. Inline actuator 118 may be an assembly (and may alternatively be referred to as an “inline actuation assembly”) that includes various mechanically-actuable elements having various form factors, such as the button depicted in FIG. 1, a rocker switch, a toggle switch, a scrolling wheel, a capacitive touchpad, etc. Inline actuator 118 may be actuable to cause a signal to be transmitted to docking station 104 or computing device 102. The signal may, for instance, directly or indirectly cause computing device 102 to transition from a first power state to a second power state.

As shown by the call-out 117 in FIG. 1, inline actuator (or “inline actuation assembly”) 118 may also include signal delivery circuitry 119 that can be operated by mechanical interaction with any of those mechanically-actuable elements mentioned previously. This mechanical interaction may cause or enable the signal delivery circuitry 119 to generate and/or transmit various types of signals to different components. In some examples, signals generated by signal delivery circuitry 119 may be USB signals.

In some examples, signal delivery circuitry 119 may generate a device-specific control signal, e.g., as part of a USB signal. For example, the device-specific control signal may be a mute-toggle signal that mutes or unmutes a microphone, a camera-toggle signal that causes a camera to activate or deactivate its vision sensor and/or shutter, a a capture-picture signal that causes a camera to transition into a temporary state in which its shutter is open (e.g., to take a picture), an input-source toggle signal to cause a monitor to toggle between various sources, a print signal, a fax signal, a scan signal, etc.

In some examples, inline actuator 118 may include a fingerprint sensor that captures fingerprint data indicative of a person's fingerprint. In some such examples, signal delivery circuitry 119 may analyze the fingerprint data locally and/or may transmit the data to, for instance, computing device 102. Computing device 102 may then cause this fingerprint data to be authenticated, locally at computing device 102 or elsewhere. In some examples, if the authentication is successful, the person may be permitted to use (e.g., wake up and/or unlock) computing device 102 (similar to the person using a fingerprint onboard computing device 102). In some such examples, one interaction with the fingerprint sensor may both cause circuitry 119 to activate computing device 102 from a sleep state to a working state, and may facilitate the authentication just described. Put another way, the person can both wake up and authenticate themselves to computing device 102 with one touch of the fingerprint sensor.

In some examples, operation of signal delivery circuitry 119 via actuation of inline actuator 118 may be similar functionally to pressing a “power” or “wake” button provided on docking station 104, or to pressing a power/wake button on computing device 102. For example, signal delivery circuitry 119 may resemble or even replicate circuitry (not depicted) that is operated by a power/wake button on docking station 104 or computing device 102. It may also be similar functionally to partially or completely opening an otherwise-closed laptop computing device in order to wake it up. Thus, in some examples, inline actuator 118 may be thought of as a “remote” power/wake button. In some examples, the signal sent from signal delivery circuitry 119 upon actuation of inline actuator 118 may be a wake signal that replicates or is similar to a wake signal sent from a power/wake button on docking station 104 or computing device 102.

Many people store docking station 104 in hard-to-reach locations such as behind a monitor, underneath a monitor stand or desk, etc. And a laptop's power button is often located inside its lid, which makes such a button inaccessible if the laptop is closed. Accordingly, if inline actuator 118 is incorporated into and/or immediately proximate the connector (whether first connector 108 or second connector 110) that is plugged into computing device 102, then inline actuator 118 may be readily accessible to a person. This may make it easier, more intuitive, and/or less cumbersome to awaken computing device 102 than, for instance, having to partially or completely open a laptop lid, or to press a hard-to-reach and/or inaccessible power button on docking station 104 or on computing device 102, as examples. The functionality and description of the example depicted in FIG. 1 is equally applicable to other examples, such as the example depicted in FIG. 2.

In FIG. 1, inline actuator 118 is incorporated into first connector 108. Consequently, when computing device 102 is attached to docking station 104 using apparatus 106, inline actuator 118 is at a location immediately proximate computing device 102. Assuming computing device 102 is more readily accessible to a person than docking station 104, this location may be more readily reachable by the person than, for instance, another location closer to docking station 104. In other examples, inline actuators configured with selected aspects of the present disclosure may be positioned elsewhere, such as immediately proximate and/or incorporated into second connector 110, halfway between first connector 108 and second connector 110, etc.

Moreover, in some examples, apparatus 106 may be directionally agnostic as to how it operably couples computing device 102 and docking station 104. Suppose, for example, contacts 114 and 116 are the same type of male contacts, then first connector 108 could be connected to docking station 104 and second connector 110 could be connected to computing device 102, opposite to what is depicted in FIG. 1. A person may prefer this arrangement where, for example, docking station 104 is more easily accessible than computing device 102. Actuation of inline actuator 118 may or may not cause the same signals to be generated under such circumstances. For example, the same signal may be sent to both computing device 102 and docking station 104, or a different signal may be sent to each.

As mentioned previously, actuation of inline actuator 118 may cause a signal to be transmitted to docking station 104 and/or computing device 102 to directly or indirectly cause computing device 102 to transition from a first power state to a second power state. In some examples, the first power state may be, for instance, a sleep state in which various hardware components of computing device 102 are deactivated. In some such examples, the second power state may be a working state in which computing device 102 may be operated to perform various computing tasks. In various examples, the signal may be, for instance, a USB signal (e.g., command) to which USB peripheral devices are designed to be responsive.

In some examples, inline actuator 118 transmits the signal to docking station 104. Docking station 104 then transmits to computing device 102 either a replication of the existing signal or a new signal. Meanwhile, docking station 104 may also transition other hardware component(s), such as port(s) 120 and/or peripheral device(s) coupled to port(s) 120, between various states. For example, docking station 104 may deactivate a monitor (not depicted in FIG. 1) connected to docking station 104 to place the monitor in a sleep state, or may activate the monitor to place it in an active or working state in which the monitor displays graphics generated by computing device 102. In other examples, inline actuator 118 may transmit the signal directly to computing device 102, which in turn may cause hardware aspect(s) of docking station 104 to transition between states.

FIG. 2 depicts a different apparatus configured with selected aspects of the present disclosure. In FIG. 2, components that are similar to those depicted in FIG. 1 are numbered similarly, except that they begin with a “2” instead of a “1.” In FIG. 2, inline actuator 218 is not incorporated into first connector 208 of a cable 206. Instead, inline actuator 218 is incorporated into a removable component that will be referred to herein as a “dongle” 222.

Similar to first connector 108 in FIG. 1, dongle 222 includes a male contact 224 that can be inserted into a corresponding female slot (not depicted) in computing device 102. Unlike first connector 108, dongle 222 includes its own female port 226 that is sized and shaped to receive male contact 214 of first connector 208 (or male contact 216 of second connector 210 assuming cable 206 is directionally agnostic).

Thus, dongle 222 may be removably attached to computing device 202, and then cable 206 may be removably attached to dongle 222. Operation of inline actuator 218 may otherwise operate similarly to operation of inline actuator 118 of FIG. 1. The main difference from a user's perspective is that dongle 222 may be smaller than a full-cable apparatus such as apparatus 106 in FIG. 1. In that example, the dangle 222 may be somewhat more convenient to carry than a full cable, for example.

In some examples, dongle 222 may include a mechanical securing mechanism to be manipulated to selectively permit or prohibit removal of the first or second connector from the docking station or laptop computer. This mechanical securing apparatus may take the form of, for instance, a screw or bolt that can be coupled with a complementary element on computing device 202 or docking station 204. In other examples, the locking mechanism may take the form of a latch, or a cable that extends from dongle 222 and that includes an end piece sized and shaped to be securely inserted into a security slot of computing device 202.

Inline actuators as described herein are not limited to transitioning computing devices and/or hardware component(s) between different power states. In some examples, inline actuators configured with selected aspects of the present disclosure may be actuable to transition a variety of different hardware components, such as peripheral devices connected to a docking station, between a variety of different operational states.

FIG. 3 schematically depicts an example of how an apparatus 306 that includes an inline actuator 318 and signal delivery circuitry 319 may be operated to transition a variety of different components between different states. In FIG. 3, inline actuator 318 and circuitry 319 are incorporated once again with a first connector 308, similar to FIG. 1. However, this is not meant to be limiting. Other arrangements, such as arrangements similar to the dangle-based arrangement in FIG. 2, are also contemplated for implementation with features of the present disclosure described in relation to FIG. 3. Various elements of FIG. 3 are labeled similarly to corresponding components of FIGS. 1 and 2, except they begin with a “3.” The description corresponding to such elements, therefore, is not repeated in its entirety, for brevity.

In FIG. 3, docking station 304 includes a plurality of ports 320 that are operably coupled with each other via a bus 358. As noted previously, ports 320 and bus 358 may take various forms, such as various USB-based technologies. Alternatively, in some examples, docking station 304 may include ports and/or buses that support multiple different combinations of technologies, such as USB-C plus USB-A, USB plus HDMI, DP plus USB, AVI plus HDMI, etc,

Coupled to a first port 320 of docking station 304 is a microphone-equipped camera, sometimes referred to as a “webcam” 360. Coupled to a second port 320 of docking station 304 is a printer 362. In some examples, printer 362 take the form of a multifunctional center (“MFC”) that may include other integral devices, such as a scanner.

Coupled to a third port 320 of docking station 304 is a wireless mouse dangle 364 that wirelessly connects to a wireless mouse 366. In other examples, a wired mouse may be connected to a port 320. Given that wireless mouse 366 may be battery-powered, techniques described herein may allow for transitioning of wireless mouse 366 between an inactive state in which it consumes little-to-no battery power and an active state in which it consumes battery power to communicate wirelessly with wireless mouse dongle 364.

Coupled to a fourth port 320 is a monitor 368. While a single monitor 368 is depicted in FIG. 3, in many scenarios, docking station 304 may be used to connect multiple monitors to computing device 302. To this end, docking station 304 may include multiple ports 320 designed specifically for connecting monitors. Additionally, these multiple ports may be the same types as each other or different types, allowing for the connection of different types of monitors (e.g., HDMI, DP, AVI, DVI, etc.) at once. And as indicated by the ellipses, in various examples docking station 304 may include any number of heterogeneous and/or homogenous ports 320.

In various examples, inline actuator 318 may be actuable to transition any of peripheral devices 360-368 between various states. These states may include but are not limited to various peripheral power states (e.g., off, on, sleep, activated, deactivated, etc.) and/or various peripheral operational states (e.g., microphone muted/unmuted, selected camera shutter speed, volume level of speaker, etc.). In some examples there may be overlap between peripheral power states and peripheral operational states. For example, a peripheral operational state of “microphone muted” may be achieved by ceasing to provide power to circuitry associated with the microphone. While a single inline actuator 318 is depicted in the figures, in some examples, multiple inline actuators may be provided to transition different hardware components between different peripheral power and/or operational states. In some examples, a single inline actuator may be actuable to transition multiple different hardware components between different peripheral and/or operational states, such as all peripheral components connected to a docking station, or a subset of peripheral components connected to a docking station.

As one example, inline actuator 318 may be actuable to cause circuitry 319 to deliver a mute-toggle signal to docking station 304 that causes webcam 360 to activate or deactivate (e.g., mute) its microphone. In an example, the inline actuator 318 may be actuable to cause circuitry 319 to deliver a camera-toggle signal to docking station 304 that causes webcam 360 to activate or deactivate its vision sensor and/or shutter. In some such examples, inline actuator 318 may be actuable to cause circuitry 319 to deliver a capture-picture signal to webcam 360 that causes webcam 360 to transition into a temporary state in which its shutter is open, e.g., to take a picture.

Inline actuator 318 may alternatively be actuable to transition printer 362 between various states. For example, if printer 362 is an MFC device with a scanner, inline actuator 318 may be actuable to operate the scanner, e.g., to scan a document for email/online storage and/or to make a photocopy of the document. As another example, if printer 362 is an MFC device that is equipped to send facsimiles (“faxes”), inline actuator 318 may be actuable to cause circuitry 319 to deliver a fax signal that causes printer 362 to capture and send a fax. As yet more examples, inline actuator 318 may be actuable to cause circuitry 319 to deliver a print signal that causes printer 362 to print, e.g., onto media such as paper, whatever content is currently rendered on a display (e.g., 368), a currently active document, whatever is currently captured by a camera (e.g., webcam 360), etc.

In some examples, inline actuator 318 may be actuable to transition monitor 368 between various states. As one example, inline actuator 318 may be actuable toggle through multiple color profiles or color “blocks” that monitor 368 is designed to implement. As another example, inline actuator 318 may be actuable to cause circuitry 319 to deliver an input-source toggle signal to monitor 368 to toggle monitor 368 between various sources. For instance, the source for monitor 368 may be computing device 302 by default, but the source may be changed using inline actuator 318 to any other available source, such as webcam 360 and/or an antenna (not depicted) that is connected to monitor 368 directly or through docking station 304.

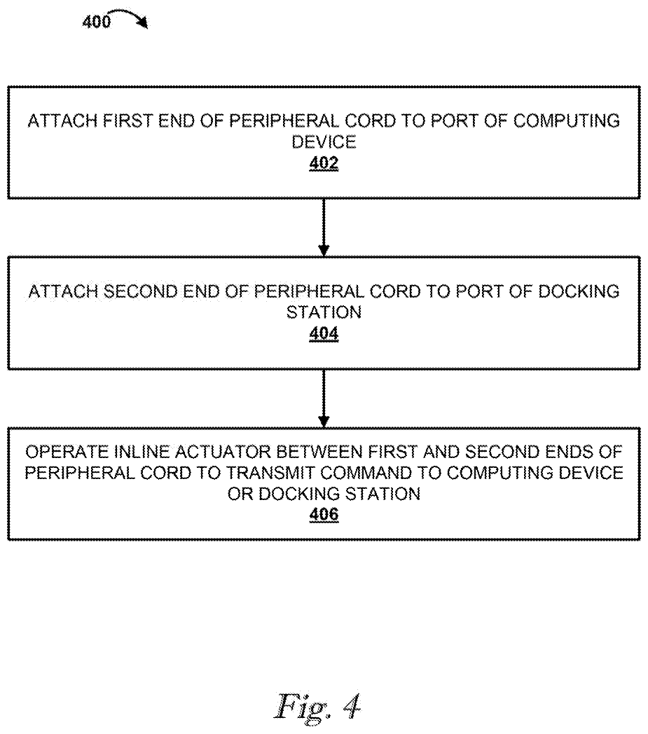

FIG. 4 depicts an example method 400 for practicing selected aspects of the present disclosure. Operations of method 400 may be reordered, omitted, or added. At block 402, a first end (e.g., 108, 308) of a peripheral cable (e.g., 106) may be attached to a port of a computing device (e,g., 102, 202, 302). At block 404, a second end (e.g., 110, 210) of the peripheral cable may be attached to a port (e.g., 120, 220, 320) of a docking station (e,g., 104, 204, 304). At block 406, an inline actuator (e.g., 118, 218, 318) between the first and second ends of the peripheral cable may be operated to transmit a signal (which may include a command) to the computing device or docking station. In various examples, the command may cause the computing device and/or docking station to transition various hardware (e.g., ports, peripheral devices, internal hardware component(s) of computing device, etc.) between various operational and/or power states.

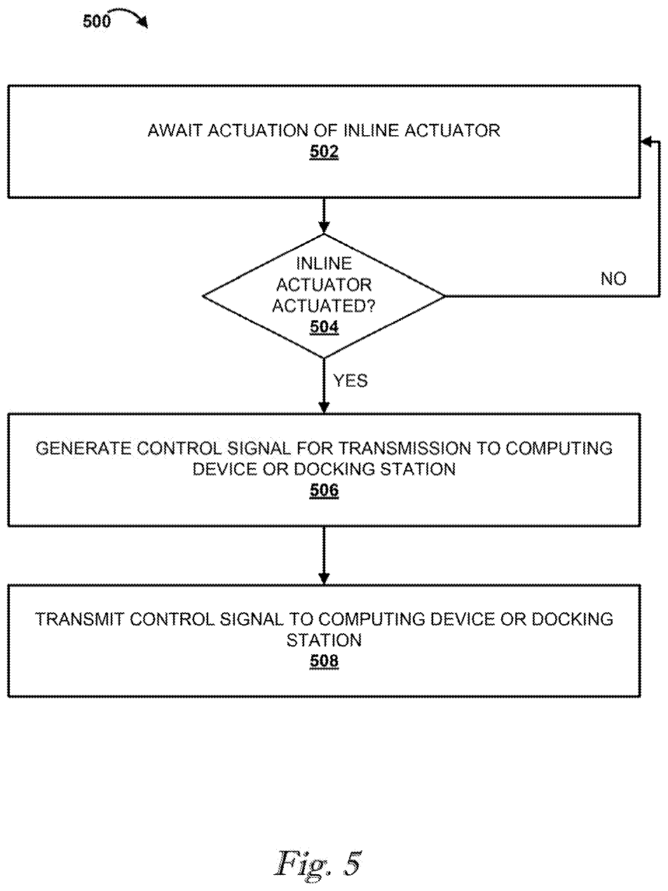

FIG. 5 depicts an example method 500 for practicing selected aspects of the present disclosure. Operations of method 500 may be reordered, omitted, or added. At blocks 502-504, an inline actuator (e.g., 118, 218 318) may await actuation. At block 504, if actuation occurs, then method 500 may proceed to block 506.

At block 506, a signal such as a control signal may be generated, e.g., by signal delivery circuitry 119, 319. That control signal may be for transmission to an electronic device to which the inline is operably coupled, such as a computing device (102, 202 302) and/or a docking station (104, 204, 304). At block 508, the control signal may be transmitted, e.g., by the signal delivery circuitry, to either the computing device or the docking station, or to both. Receipt of the control signal may cause the computing device and/or docking station to transition various hardware components between various operational and/or power states, such as a sleep state, a hibernate state, a working state, etc.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What is claimed is:

1. An apparatus to operably couple a computing device with a docking station, the apparatus comprising:
a first connector to be removably coupled with the computing device;
a second connector to be removably coupled with the docking station; and
an inline actuator coupled between the first connector and the second connector, wherein the inline actuator is actuable to cause a signal to be transmitted to the docking station or the computing device, wherein the signal is to cause the computing device to transition from a first state to a second state.

2. The apparatus of claim 1, wherein the second connector comprises a female port to removably receive a cable that is attached to the docking station.

3. The apparatus of claim 1, wherein the apparatus comprises a cable and the second connector is to be removably attached directly to the docking station.

4. The apparatus of claim 1, wherein the inline actuator comprises a button, a toggle switch, or a rocker switch.

5. The apparatus of claim 1, wherein one of the first and second states comprises a sleep state and the other of the first and second state comprises a working state.

6. The apparatus of claim 1, wherein the inline actuator is immediately proximate or incorporated into the first connector or the second connector.

7. The apparatus of claim 1, wherein the signal comprises a universal serial bus (“USB”) signal and the inline actuator comprises circuitry to generate a device-specific control signal as part of the USB signal.

8. The apparatus of claim 1, wherein the signal is to cause the docking station to transition a peripheral device attached to the docking station from a first peripheral power state to a second peripheral power state.

9. The apparatus of claim 1, wherein the peripheral device comprises a monitor.

10. A cable to connect a first electronic device to a second electronic device, the cable comprising:
a first connector at a first end;
a second connector at a second end;
an elongate flexible portion between the first and second connectors; and
an inline actuator between the first and second ends that is actuable to command the first or second electronic device to transition a hardware component between different states.

11. The cable of claim 10, wherein the inline actuator is incorporated into or immediately proximate the first or second connector.

12. The cable of claim 10, wherein one or both of the first and second connectors comprises a male contact.

13. The cable of claim 10, wherein the hardware component comprises a webcam, 14, The cable of claim 13, wherein one of the different states includes a state in which a microphone of the webcam is deactivated.

15. The cable of claim 13, wherein one of the different states includes a temporary state in which a vision sensor of the webcam is activated.
